(19) United States
(12) Patent Application Publication
(10) Pub. No.: US 2006/0091359 A1
(43) Pub. Date: May 4, 2006

(54) Organic light emitting compounds for a blue-light electroluminescent device

(76) Inventors: Jun-Liang Lai, Shuishang Hsiang (TW); Rai-Yi Chen, Pingchen City (TW); Ling Lu, Luchu Hsiang (TW)

Correspondence Address: HERSHKOVITZ & ASSOCIATES, 1725 I STREET NW, SUITE 300, WASHINGTON, DC, 20006, US

(21) Appl. No.: 10/975,982

(22) Filed: Oct. 29, 2004

(51) Int. Cl. C09K 11/06

(52) U.S. Cl. 252/301.16

(57) ABSTRACT

Organic light emitting compounds, particularly used for highly efficient blue-light electroluminescent (EL) devices, have the following representative formula:

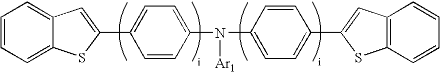

wherein i is an integer 1 or 2 and Ar₁ is an aryl group of 6 to 20 carbon atoms.

### BACKGROUND OF THE INVENTION

1. Field of the Invention

The present invention relates to organic light emitting compounds, and more particularly to organic blue-light emitting compounds used in a highly efficient blue-light electroluminescent device.

2. Description of Related Art

In recent years, organic electroluminescent devices (OEL device) have attracted attention, and practical applications have been developed for the OEL devices. Most research indicates that adding a dopant material to electroluminescent medium in light emitting layers can significantly increase the luminescence.

However, the organic electroluminescent devices still have a short life-span that is a great obstacle to the use of organic electroluminescent devices. The short life-span results from the following:

1. The organic light emitting material crystallizes when heated or deteriorates because of oxidization or lighting, which interferes with the operation of the organic electroluminescent device and causes the organic electroluminescent device to malfunction.

2. The cathode separates from the organic electroluminescent device because of dampness or oxidization.

Each organic electroluminescent device has multiple light emitting layers containing various organic light-emitting materials (compounds). Thermal treatment of the organic electroluminescent devices will cause diffusion of the organic light emitting materials, which reduces the stability of the device. Moreover, the diffusion between adjacent light emitting layers is related to the temperatures of glass transition (Tg) of the organic light emitting materials. Therefore, this problem can be resolved by using organic light emitting materials having high temperature of glass transitions (Tg).

Conventional organic light emitting materials in a blue-light eletroluminescent device are one of two types. One type is a diarylaminodistyrylarylene compound, and the other type is a perylene compound. The former type emits light close to white light and has an excellent light-emitting efficiency but has a low temperature of glass transition (Tg). The latter type has poor light-emitting efficiency.

The present invention has arisen to mitigate or obviate the disadvantages of the conventional organic light emitting materials.

### SUMMARY OF THE INVENTION

A main objective of the present invention is to provide organic light emitting compounds that make an organic blue-light electroluminescent device durable and give an organic blue-light electroluminescent device efficient light-emitting characteristics.

To achieve the foregoing objective, the organic blue-light electroluminescent device has at least one light emitting layer containing organic light emitting compounds having the following representative formula:

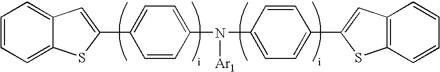

wherein “i” is an integer 1 or 2 and “Ar₁” is an aryl group of 6 to 20 carbon atoms.

By using the organic light emitting compounds of the present invention as the electroluminescent medium of the at least one light-emitting layer, the emitting efficiency of the blue-light electroluminescent device is increased, and the wave length of emitting light is of 440 nm to 500 nm.

Further benefits and advantages of the present invention will become apparent after a careful reading of the detailed description with appropriate reference to the accompanying drawings.

### DETAILED DESCRIPTION OF THE PREFERRED EMBODIMENT

Organic light emitting compounds in accordance with the present invention are particularly used for highly efficient blue-light electroluminescent (EL) devices and have the following representative formula:

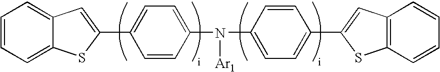

wherein “i” is an integer 1 or 2 and “Ar₁” is an aryl group of 6 to 20 carbon atoms.

The organic light emitting compounds in the forgoing representative formulation are used in at least one light-emitting layer in an organic blue-light electroluminescent device.

An organic blue-light electroluminescent device is mainly composed of a substrate, an anode, a hole-injecting layer, a hole-transporting layer, at least one light-emitting layer, an electron-transporting layer, an electron-injection layer and a cathode. These elements are formed in sequence by means of thermal vapor deposition or spin coating. When electricity is applied to the anode and the cathode, electrons and electron-holes engage with each other to emit light. The color of the emitted light depends on the organic light emitting compounds in the at least one light emitting layer.

The organic light emitting compounds in the present invention have multiple practical embodiments in the following formulas:

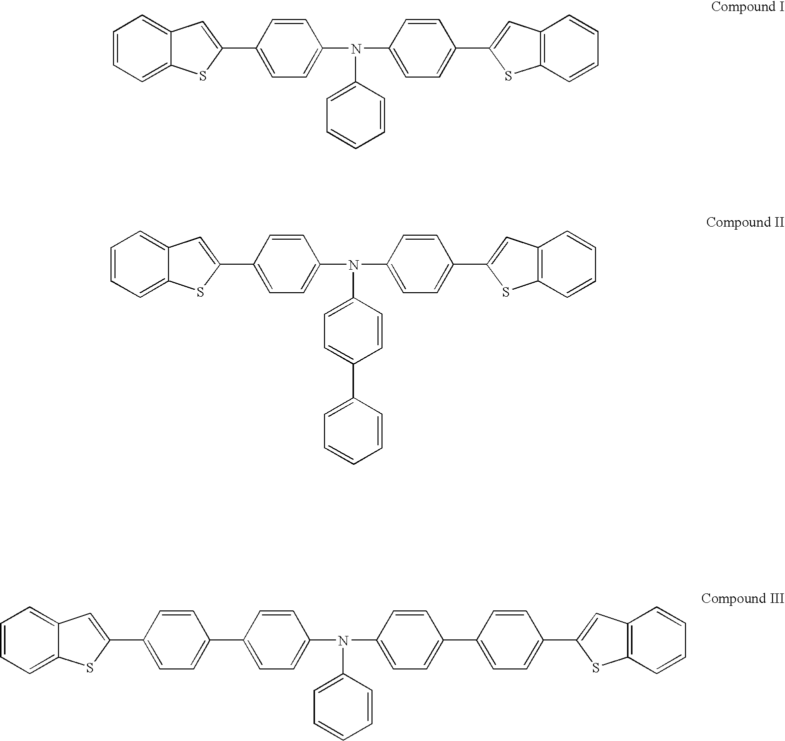

The organic light emitting compounds corresponding to the representative formula can be manufactured by the following reaction formulation:

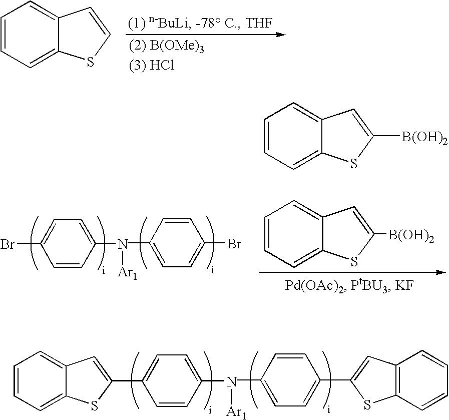

wherein “i” is an integer 1 or 2 and “Ar₁” is an aryl group of 6 to 20 carbon atoms.

The compounds obtained in the above reaction formulation can be further purified by means of column chromatography, re-crystallization and sublimation.

### EXAMPLES FOR SYNTHESIZING THE ORGANIC LIGHT EMITTING MATERIALS

### Example 1

### Compound I

### First Act: synthesization of 4,4,-di-bromo-triphenylamine

First, 5 g of aniline, 31.88 g of 1-bromo-4-iodobenzene, 213 mg of cupreous chloride, 387 mg of 1,10-phenanthroline, 18.1 g of potassium hydroxide and 107 ml of toluene were mixed in a reacting flask to form a mixture. The mixture was heated and refluxed for 18 hours in a nitrogen atmosphere. Then, the mixture was cooled to 70° C. and filtered to obtained 4,4,-di-bromo-triphenylamine in solid form. The solid of 4,4,-di-bromo-triphenylamine was further purified by adding methanol, heating to dissolve the solid again and refluxing for one hour. The methanol solution was cooled and filtered to obtain pure 4,4,-di-bromo-triphenylamine. The reaction of synthesizing 4,4,-di-bromo-triphenylamine is shown in the following formulation.

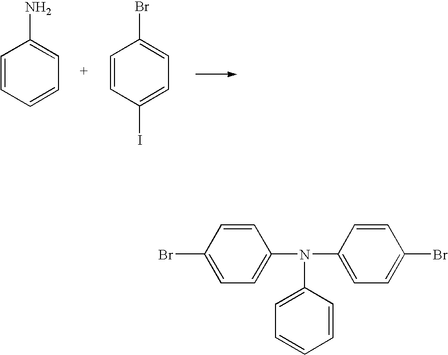

### Second Act: synthesization of compound I

In a nitrogen atmosphere, 11 g of 4,4,-di-bromo-triphenylamine obtained from the first act, 14.57 g of benzothiophene-2-boronic acid, 4.75 g of potassium fluoride, 12.2 mg of palladium acetate, 22 mg of tri-isobutyl phosphine and 54.5 ml of xylene were mixed in a reacting flask, heated to 130° C. and stirred for 1 hour to generate a yellowish solid of compound I. The yellowish solid was obtained by filtering and then further purified by extraction with methanol. Compound I was dissolved in 100 ml of methanol, and the mixture was agitated for 10 min. Then, mixture of the methanol and the yellowish solid was filtered to obtain 8.3 g of compound I (yield: 60%). Physical characteristics of compound I are:

Tg: 73° C.;

Melting point: 238.6° C.;

λₘₐₓ: 444 nm; and

Spectrum analysis: ¹H NMR (200 MHz, CDCl₃): δ 7.71˜7.82 (m), 7.57˜7.61 (m), 7.45 (bs), 7.08˜7.36 (m).

The formulation of preparing compound I is shown below:

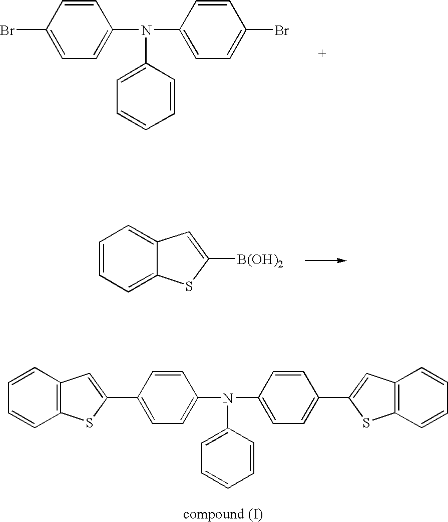

### Example 2

### Compound II

### First Act: synthesization of 4,4′,-dibromo-4″-phenyl-triphenylamine

First, 10 g of 3-amino-biphenyl, 33.42 g of 1-bromo-4-iodobenzene, 234 mg of cupreous chloride, 426 mg of 1,10-phenanthroline, 19.89 g of potassium hydroxide and 118 ml of toluene were mixed in a reacting flask to form a mixture. The mixture was heated and refluxed for 18 hours in a nitrogen atmosphere. Then, the mixture was cooled to 70° C. and filtered to obtained 4,4′,-dibromo-4″-phenyl-triphenylamine in solid form. The 4,4′,-dibromo-4″-phenyl-triphenylamine solid was further purified by adding methanol, heating to dissolve the solid again and refluxing for one hour. The methanol solution was cooled and filtered to obtain 10 g of pure 4,4′,-di-bromo-4″-phenyl-triphenylamine in gel form. The reaction of synthesizing 4,4′,-di-bromo-4″-phenyl-triphenylamine is shown in the following formulation.

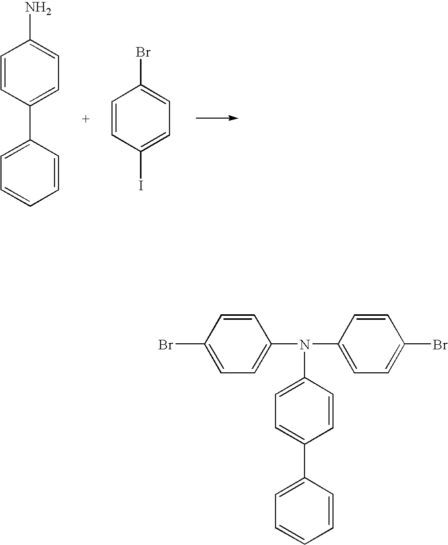

### Second Act: synthesization of Compound II

In a nitrogen atmosphere, 9 g of 4,4′,-di-bromo-4″- phenyl-triphenylamine obtained from the first act, 10.03 g of benzothiophene-2-boronic acid, 3.27 g of potassium fluoride, 8.4 mg of palladium acetate, 15 mg of tri-isobutyl phosphine and 37.5 ml of xylene were mixed in a reacting flask, heated to 130° C. and stirred for 1 hour to generate a yellowish solid of compound II. The yellowish solid was obtained by filtering and then further purified by extraction with methanol. Compound II was dissolved in 100 ml of methanol, and the mixture was agitated for 10 min. Then, the mixture of the methanol and the yellowish solid was filtered to obtain 3.8 g of compound II (yield: 34.5%). Physical characteristics of compound II are:

Tg: 103° C.;

Melting point: 260° C.; and

λₘₐₓ: 466 nm.

The formulation of preparing compound II is shown below:

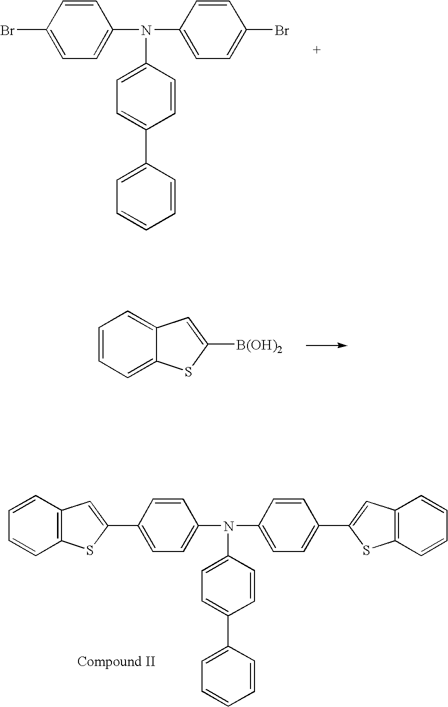

### Example 3

### Compound III

### First Act: synthesization of 4,4′,-bis(4-dibromophenyl)-triphenylamine

First, 7 g of aniline, 54 g of 1-bromo-4-iodobenzen, 298 mg of cupreous chloride, 542 mg of 1,10-phenanthroline, 25.27 g of potassium hydroxide and 150 ml of toluene were mixed in a reacting flask to form a mixture. The mixture was heated and refluxed for 18 hours in a nitrogen atmosphere. Then, the mixture was cooled to 70° C. and filtered to obtained 4,4′,-bis(4-dibromophenyl)-triphenylamine in solid from. The solid of 4,4′,-bis(4-dibromophenyl)-triphenylamine was further purified by adding methanol, heating to dissolve the solid again and refluxing for one hour. The methanol solution was cooled and filtered to obtain 5.2 g of pure 4,4′,-bis(4-dibromophenyl)-triphenylamine in gel form. The reaction of synthesizing 4,4′-bis(4-dibromophenyl)-triphenylamine is shown in the following formulation.

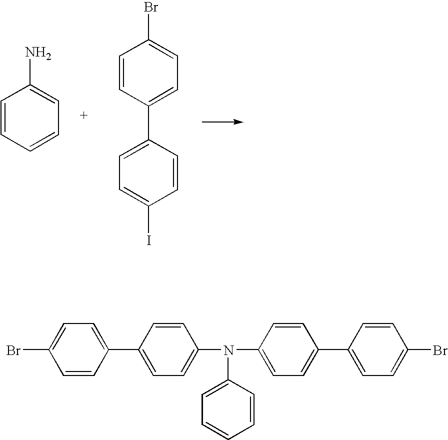

### Second Act: synthesization of compound III

In a nitrogen atmosphere, 5 g of 4,4′,-bis(4-dibromophenyl)-triphenylamine obtain from the first act, 4.8 g of benzothiophene-2-boronic acid, 1.6 g of potassium fluoride, 4 mg of palladium acetate, 7.3 mg of tri-isobutyl phosphine and 18 ml of xylene were mixed in a reacting flask, heated to 130° C. and stirred for 1 hour to generate a yellowish solid of compound III. Compound III was obtained by filtering and then further purified by extraction with methanol. The compound III was dissolved in 100 ml of methanol, and the mixture was agitated for 10 min. Then, the mixture of the methanol and the yellowish solid was filtered to obtain 1.4 g of compound III (yield: 23%). Physical characteristics of compound III are:

Tg: 162° C.;

Melting point: 370° C.;

λₘₐₓ: 456 nm; and

Spectrum analysis: ¹H NMR (200 MHz, CDCl₃): δ 7.72˜7.83 (m), 7.39˜7.64 (m), 7.17˜7.34 (m).

The formulation of preparing compound III is shown below:

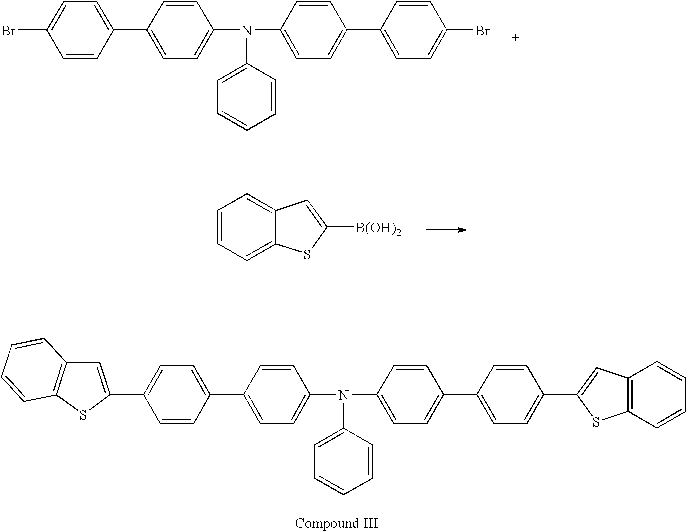

### EXAMPLES FOR ELECTROLUMINESCENT DEVICES CONTAINING THE ORGANIC BLUE-LIGHT EMITTING COMPOUNDS IN THE PRESENT INVENTION

### Example 1

An ITO substrate with a resistivity of 20 Ω/cm² was mounted on a vapor-depositing machine. The vapor-depositing machine had a first quartz crucible containing (N,N′-di(naphthalene-1-yl)-N,N′-diphenyl-benzidine, NPB), a second quartz crucible containing 9,10-di(2-naphthyl)anthracene, β-DNA), a third quartz crucible containing compound I, a fourth quartz crucible containing 4,7-di-phenyl-1,10-phenanthroline, a first graphite crucible containing aluminum and a second graphite crucible containing lithium fluoride.

Pressure of the vapor-depositing machine was reduced to 8×10⁻⁶ torr. The NPB in the first quartz crucible was heated to a vapor and deposited on the substrate to as the hole-transporting layer with a 40 nm thickness. Then, the β-DNA in the second quartz crucible was heated to a vapor and deposited on the hole-transporting layer to form the light emitting layer with a thickness of 30 nm. Wherein, the light emitting layer further contained compound I that was 3% weight of the light emitting layer. An electron-transporting layer was made of 4,7-di-phenyl-1,10-phenanthroline using the same heating and deposition technique and formed on the light emitting layer. The second graphite crucible was then heated to vaporize the lithium fluoride and deposit the lithium fluoride on the electron-transporting layer to form an electron-injecting layer with a thickness of 0.8 nm. Lastly, an aluminum cathode having a thickness of 100 nm was formed on the electron-injecting layer to achieve a first blue-light electroluminescent device.

When a direct current of 10 volts was applied to the first blue-light electroluminescent device, blue light was emitted with a light intensity of 2320 cd/m² and wavelength of 450 nm.

### Example 2

A second blue-light electroluminescent device has a same structure and same composition of each layer as the one in example 1, except 3% weight of compound II was substituted for compound I in the light emitting layer.

When a 10 volt direct current was applied to the second electroluminescent device, blue light was emitted with a light intensity of 2610 cd/m² and wavelength of 465 nm.

### Example 3

A third blue-light electroluminescent device has the same structure and same composition of each layer as the one in example 1, except 3% weight of compound III was substituted for compound I in the light emitting layer.

When a 10 volt direct current was applied to the third electroluminescent device, blue light was emitted with a light intensity of 3120 cd/m² and wavelength of 455 nm.

According to the foregoing examples of the blue-light electroluminescent devices, the organic blue-light emitting compounds make the blue-light electroluminescent devices have excellent light-emitting efficiency of a light intensity between 2023-3120 cd/m².

The invention has been described in detail with particular reference to certain preferred embodiments. However, variations and modifications can be effected within the spirit and scope of the invention.

Although the invention has been explained in relation to its preferred embodiment, many other possible modifications and variations can be made without departing from the spirit and scope of the invention as hereinafter claimed.

What is claimed is:

1. Organic light emitting compounds for a blue-light electroluminescent device, the organic light emitting compounds having a representative formula of: 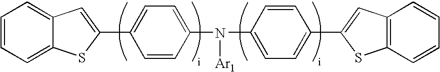
wherein, i is an integer 1 or 2 and Ar₁ is an aryl group of 6 to 20 carbon atoms.

2. The organic light emitting compounds as claimed in claim 1, wherein the compounds formed from the general formula include a compound I that is:

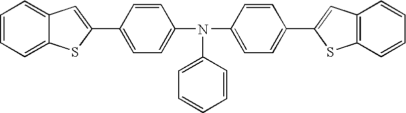

3. The organic light emitting compounds as claimed in claim 1, wherein the compounds formed from the general formula include a compound II that is:

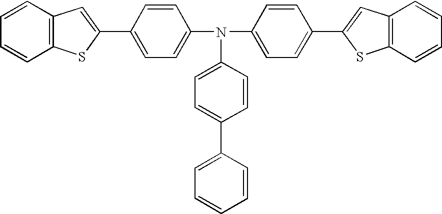

4. The organic light emitting compounds as claimed in claim 1, wherein the compounds formed from the general formula include a compound III that is:

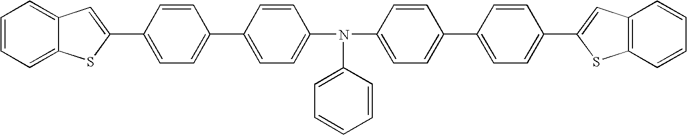

5. An blue-light electroluminescent device using at least one organic light emitting compound as claimed in claim 1, wherein the blue-light electroluminescent device comprises at least one light emitting layer having the at least one organic light emitting compound.

6. The blue-light electroluminescent device as claimed in claim 5, wherein each light emitting layer contains 3 w/w % of at least one organic light emitting compound.
